(19) United States
(12) Patent Application Publication
(10) Pub. No.: US 2025/0242499 A1
(43) Pub. Date: Jul. 31, 2025

(54) EMOTIVE COMPANION

(71) Applicants: Shota Aoyagi, San Francisco, CA (US); Anthony Ashcroft, San Francisco, CA (US); Jeremy Bataillou, San Francisco, CA (US); Jonathan Gomez Garcia, San Francisco, CA (US); Roger Guyett, Mill Valley, CA (US); Jonathan P. Ive, San Francisco, CA (US); Patrick Kessler, San Francisco, CA (US); Benoit Louzaouen, San Francisco, CA (US); Michael Matas, Healdsburg, CA (US); Christopher Wilson, Sonoma, CA (US); Suhang Zhou, San Francisco, CA (US)

(72) Inventors: Shota Aoyagi, San Francisco, CA (US); Anthony Ashcroft, San Francisco, CA (US); Jeremy Bataillou, San Francisco, CA (US); Jonathan Gomez Garcia, San Francisco, CA (US); Roger Guyett, Mill Valley, CA (US); Jonathan P. Ive, San Francisco, CA (US); Patrick Kessler, San Francisco, CA (US); Benoit Louzaouen, San Francisco, CA (US); Michael Matas, Healdsburg, CA (US); Christopher Wilson, Sonoma, CA (US); Suhang Zhou, San Francisco, CA (US)

(21) Appl. No.: 19/041,925

(22) Filed: Jan. 30, 2025

Related U.S. Application Data
(60) Provisional application No. 63/627,210, filed on Jan. 31, 2024.

(51) Int. Cl. B25J 11/00; G06F 1/16

(52) U.S. Cl. CPC B25J 11/001; G06F 1/1601

(57) ABSTRACT

An electronic device configured to operate as a personal companion configured to provide contextual information in response to a command to perform a task, while performing a task, after performing a task, or with respect to the outcome of a task (such as the results of a search query or other primary information). This contextual information may characterize the task, its performance, or its outcome and, in some embodiments, this contextual information may elicit, emulate, or remind a user of an emotion or an emotional gesture.

### CROSS-REFERENCE TO RELATED APPLICATIONS

This application is a nonprovisional patent application of and claims the benefit under 35 U.S.C. § 119(e) of U.S. Provisional Patent Application No. 63/627,210, filed Jan. 31, 2024, and titled “Emotive Assistant,” the contents of which are incorporated herein by reference in its entirety.

### FIELD

The described embodiments relate generally to electronic personal assistants. More particularly, the present embodiments relate to an electronic personal companion configured to emulate certain human gestures through motion of its physical components.

### BACKGROUND

Electronic devices can be configured to operate as personal assistants, performing a variety of tasks in response to a user command. Personal assistants are widespread and may provide output, such as confirmations of tasks or conveying the results of a task, through audible or visual outputs. Generally, current electronic personal assistants are well-suited to convey information but lack the ability to contextualize that information, for example by conveying or evoking emotion.

### SUMMARY

Embodiments described herein relate generally to an electronic product configured to operate as a personal companion, including: facilitating search queries and returning relevant information; scheduling calendar items such as tasks, reminders, and meetings; receiving, initiating, and/or transmitting communications to or from another person; health monitoring; executing user commands; executing applications; and so on. Further, the electronic product may provide contextual information in response to a command to perform a task, while performing a task, after performing a task, or with respect to the outcome of a task (such as the results of a search query or other primary information). This contextual information may characterize the task, its performance, or its outcome and, in some embodiments, this contextual information may elicit or remind a user of an emotion. Accordingly, the electronic product may be referred to herein as an “emotive companion.”

Emotive companions, as described herein, provide primary information in response to a user command. Examples of primary information include responses to search queries, calendar appointments, electronic messages initiated or received by the electronic companion, and so on. Essentially, any data generated by, retrieved by, or received by the emotive companion in response to a user command is primary information.

One embodiment described herein takes the form of an electronic product, comprising: a base; an arm rotatably and slidably connected to the base; and a head rotatably connected to the arm, the head comprising: a first head section; and a second head section; wherein: the first head section and second head section are rotatable about a head axis; the first head second and second head section are configured to display primary information; the head and the arm are configured to move relative to the base to convey contextual information; and the contextual information relates to the primary information and emulates a human gesture.

Another embodiment described herein takes the form of a method for providing contextual output, comprising: receiving a user input; determining an output based on the user input, the output comprising primary information; determining whether contextual information corresponding to the primary information is to be provided, the contextual information configured to elicit an emotion from a viewer; in the event the contextual information is to be provided, selecting the contextual information from a set of contextual information based on the emotion to be elicited; and outputting the primary information and the contextual information; wherein: the contextual information is motion-based.

Yet another embodiment described herein takes the form of a method for evoking an emotion in a user in response to presenting primary information, comprising: receiving an input from the user; determining an output related to the input; determining if contextual information is appropriate, given the input and the output; in the event the contextual information is appropriate, providing the contextual information in the form of a movement designed to evoke an emotion in the user; and providing the output.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an emotive companion in a standby state.

FIG. 2a shows the emotive companion of FIG. 1 in a first waking state.

FIG. 2b shows the emotive companion of FIG. 1 in a second waking state.

FIG. 3 shows the emotive companion of FIG. 1, illustrating motion of its head and arm relative to its base.

FIG. 4 shows the emotive companion of FIG. 1, illustrating positioning of its head with respect to its arm and base.

FIG. 5 shows the emotive companion of FIG. 1 with its head and arm in a different position than that shown in FIG. 4.

FIG. 6 shows a rear of the emotive companion of FIG. 1.

FIG. 7 is a flowchart illustrating example operations of a sample emotive companion.

FIG. 8 is a system diagram of the components of a sample emotive companion.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments described herein relate generally to an electronic product configured to operate as a personal companion, including: facilitating search queries and returning relevant information; scheduling calendar items such as tasks, reminders, and meetings; receiving, initiating, and/or transmitting communications to or from another person; health monitoring; executing user commands; executing applications; and so on. Further, the electronic product may provide contextual information in response to a command to perform a task, while performing a task, after performing a task, or with respect to the outcome of a task (such as the results of a search query or other primary information). This contextual information may characterize the task, its performance, or its outcome and, in some embodiments, this contextual information may elicit or remind a user of an emotion. Accordingly, the electronic product may be referred to herein as an “emotive companion.”

Emotive companions, as described herein, provide primary information in response to a user command. Examples of primary information include responses to search queries, calendar appointments, electronic messages initiated or received by the electronic companion, and so on. Essentially, any data generated by, retrieved by, or received by the emotive companion in response to a user command is primary information.

“Contextual information,” by contrast, includes outputs generated by the emotive companion in order to convey to a user and/or viewer some quality of the primary information. An emotive companion may convey different types of contextual information. For example, the contextual information may indicate a measure of accuracy, reliability, certainty (e.g., a determination of how closely actual information or task performance matches expected information or task performance), time taken to perform a task, and so on. The contextual information may also indicate whether a follow-up task is required or may be desired or useful to a user. The contextual information may likewise indicate, convey, or be derived from some circumstance of the primary information. For example, the contextual information may convey information regarding a sender of a message, where the message is the primary information.

The emotive companion may convey contextual information in a variety of ways including visually and/or audibly. Typically, but not necessarily, the contextual information is not simply a verbal or visual recitation of the information itself. Generally, the contextual information is non-verbal in nature. Contextual information may be conveyed, for example, by particular motion(s) of the emotive companion or portions of the emotive companion; such motions may be designed to emulate or evoke certain human gestures, and/or emotions, such as a shrug, back-and-forth (waffling) motion of a hand, nodding, shaking one's head, bouncing in place, and so on. It should be appreciated that these gestures each generally convey different emotions or states when performed by a person: shrugging may indicate uncertainty or a lack of knowledge; waffling shows a measure of dissatisfaction or lack of quality; nodding conveys agreement; shaking one's head illustrates disagreement; bouncing in place conveys excitement; and so on. Similarly, certain gestures may be associated with or assigned to certain people or entities, such that the gesture, when performed, conveys the identity of a person or entity associated with the primary information. The list of gestures used to provide contextual information is not exhaustive or limiting.

Further, different human gestures may have different meanings in different cultures or different locations. Accordingly, the emotive companion may utilize different gestures to convey the same contextual information based on data indicating a particular culture of a user (for example, a language selected by a user for interacting with the companion), a location of a user (for example, geographical coordinates obtained from a GPS or other location-determining system), and so on. A user may instead select a set of motions for the emotive companion that are used to convey contextual information from a number of preset options or groups, or may fully customize one or more contextual motions. A “contextual motion” is a motion that conveys, or is intended to convey, contextual information. Contextual motions may be selected from a preexisting database or library of motion, customized by a user, customized over time by the emotive companion itself, and so on.

As mentioned above, contextual information need not be motion-based. Some emotive companions may use sound, light or other visual cues, haptics, or the like instead of motion. That said, motion-based contextual information can relatively easily mimic or evoke a gesture associated with a particular emotion or state, and so is often more efficient and/or intuitive in conveying the contextual information.

Emotive companions may come in many shapes, sizes, and/or form factors. Further, different emotive companions may use different types of motion to provide contextual information. In many cases, the motion of an emotive companion, optionally along with certain physical features, are configured such that a user (or other observer) anthropomorphizes the companion and/or the motion. Humans innately look for meaning in many things, ascribing emotions, thoughts, and/or intentions to animals and objects based on the way such animals or objects look and move, among other things. Leveraging this principle of anthropomorphization permits emotive companions, as described herein, to be perceived by a user or other observer as more than a simple machine. Likewise, the motion of the companion may have particular meanings ascribed to it by a user; indeed, the companion's motion is specifically designed to evoke such meanings in an onlooker. The meanings may be feelings or emotional states attributed to the companion (curiosity, confusion, eagerness, and so on), characteristics (playfulness, decisiveness, caring, responsibility, and the like), or other human characteristics. Through leveraging common human experience and our anthropomorphic tendencies, the emotive companion may employ specific motions to create particular feelings and/or reactions in a person. These motions may be referred to herein as “emotive motions.” Emotive motion helps anthropomorphize the emotive assistant.

Oftentimes, emotive motions are linked to, or convey information about, a status of the emotive companion. For example, emotive motions may be used when the companion activates (e.g., is turned on, wakes from a sleep state, accepts an input, and so on), interacts with a user, retrieves and/or displays information, in order to attract a user's attention, deactivates, in response to an external stimulus or detecting something in an environment (such as a person, object, temperature, lighting, or the like), changes state, and so on. In this manner, emotive motions are one example of contextual information.

Emotive companions are discussed herein extensively in relation to providing information, and particularly contextual information. Such companions are also discussed in the context of retrieving and presenting information. However, these functions are but a fraction of the capabilities of an emotive companion.

Emotive companions may provide companionship for people, particularly the elderly and individuals who live alone. Emotive companions may incorporate a sophisticated set of sensors used to determine a person's mood and interact with them (or leave them alone) accordingly. Likewise, an emotive companion may determine if a person is engaged in particular activities and join them in those activities, thereby enhancing the person's experience. Artificial intelligence may be incorporated into an emotive companion to allow it to learn and recognize a person's preferences, likes, dislikes, routines, reactions to the companion's emotive motion, and the like. The emotive companion may draw on this learning to customize itself for a person, for example by modifying its emotive motions to more reliably elicit a response or emotion from a particular person. In some instances, this learning-modification loop feeds on itself, such that every modification of the emotive companion's actions is measured against the person's reactions until the companion's actions are customized to the point that they elicit the desired response (whether emotional or physical) from the person. A person's emotional response may be determined by tracking changes in expression, motion, audible statements, and the like through appropriate sensors, for example.

Emotive companions often employ artificial intelligence (or other types of machine learning or programming) to predict if motion is or will be necessary, what type of emotive motion to use, and to otherwise be proactive in terms of their motion. That is, an emotive companion may implement intelligent motion; certain motions may be both emotive and intelligent. As one example, an emotive companion tracks a person's position in order to interact with that person. As the person moves, the emotive companion may swivel, tilt, turn, or otherwise move to keep the person in view of its sensors. Further, the companion's motion may be an emotive motion-the companion may appear to overbalance momentarily, exaggerate its turn or other motion, move past and return to center (or to put into view) the person, and the like-in order to signify that the companion is focused on the person and thus “paying attention” to them.

Intelligent motion permits an emotive companion to act proactively or in real time (or near-real time). The tracking example given above may be performed either in real time by moving as the person moves or proactively by determining to where a person is moving or when a person may move and acting in advance of such motion. Emotive companions may move intelligently to reorient themselves to: change a field of view (for example, to sense multiple people or objects simultaneously, or to sense a wider or narrower area or volume); map a space by moving through at least portions of the space; interact with objects in a space (such as activating or deactivating objects, illuminating an object, returning to a charging station, or the like); reorient in order to more effectively interact with a person; draw attention to itself; and so on. Intelligent motion allows the emotive companion to move in service to another function, whether the display of information, acceptance of an input, tracking of a person, or the like. Essentially, intelligent motion is context-based; the emotive companion acts in a manner suited to the context of its actions in combination with its user and its space.

Emotive companions are particularly effective at using contextual motion (whether or not intelligent and/or emotive) to enhance their utility. Generally, but not necessarily, many of an emotive companion's outputs are accompanied by some corresponding motion or preceded by some such motion. The emotive companion thus draws attention to itself prior to, or while engaging in, some form of interaction or presentation. This combination of utility and motion enhances the information provided to a user, commands his or her attention, and helps establish an emotional bond between the user and companion. Generally, the companion's contextual motion can be considered a form of body language and so another level of communication beyond audiovisual, in the same manner that humans interpret one another's body language to provide context to speech. Thus, an emotive companion's motion generally has two purposes: utility (e.g., contextual motion) and emotion (e.g., emotive motion).

Embodiments described herein may utilize one or more sensors, such as cameras, light sensors (including sensors that sense wavelengths within, above, or below the visible light spectrum), ultrasound sensors, depth sensors, VCSEL-based sensors, temperature sensors, proximity sensors (including LIDAR and RADAR-based sensors), and so on in order to sense an environment and/or determine locations of people or other objects within the environment. This environmental awareness may permit the emotive companion to exhibit some sense of spatial awareness, constraining (or allowing) its motion in accordance with the position of people and/or objects. For example, a motion of the emotive companion may be made towards a person in an environment to signal that the companion is directing the motion (and thus the emulated emotion, or attempt to elicit emotion) at that person. Alternatively, a motion may be made towards an object in the environment to direct a person's attention thereto. An emotive companion with appropriate spatial awareness of its environment may gesture or make other motions (including movement) between people or between a person and a location or object to draw the person's attention. In this manner, the emotive companion may seem more lifelike and thus more anthropomorphized.

Similarly, the emotive companion may coordinate its motion (including movement) with the display or other output of information, including animations, in order to emphasize the informational output. Again, this may enhance the likelihood of drawing a user's attention, directing the user's attention to the information or another object in the environment, or otherwise facilitate the conveyance of information, particularly where the coordinated motion and/or informational display is configured to emulate or elicit emotion.

Emotive motions and intelligent motions are not exclusive; some motions performed by an emotive companion may be both. Further, both emotive motions and intelligent motions may be contextual motions.

These are partial examples of how an emotive companion may provide emotional support and fulfillment for a person in a manner similar to a pet or another person.

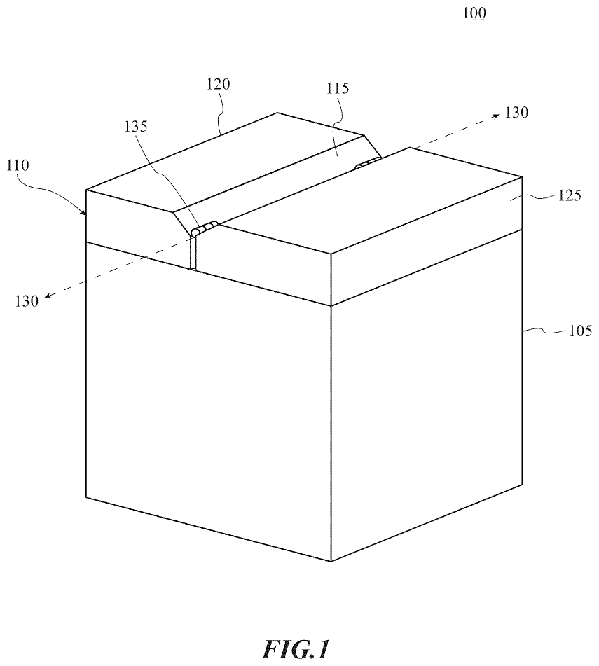

These and other embodiments are discussed below with reference to FIGS. 1-8. However, those skilled in the art will readily appreciate that the detailed description given herein with respect to these Figures is for explanatory purposes only and should not be construed as limiting.

FIG. 1 shows a sample emotive companion 100 in a standby or base state. The emotive companion 100 is closed although its base 105 and head 110 are still visible. (The aggregate physical elements of the emotive companion are referred to herein as a “shell.”) In this embodiment, the head and base together form a generally cubical shape when the companion is in the standby state, and certain embodiments may have rounded or chamfered corners. Other embodiments may form other geometric or non-geometric shapes in the standby state.

As can be seen, in this particular embodiment the head is divided into first and second head sections 120, 125 by a scam. A channel 115 is defined along the seam and extends onto each of the first and second head sections. The seam permits the first head section 120 to move independently of the second head section 125, and vice versa. A width of the channel sets the maximum distance each head section can rotate about an axis defined along the seam (the “head axis” 130), generally on a hinge connecting the two head sections to one another. That is, since the head axis of rotation 130 is not coplanar with an upper surface of the head 110, as viewed with respect to the orientation shown in FIG. 1, the channel width determines at what point during axial rotation the first head section's upper surface will contact the second head section's upper surface, thereby preventing further axial rotation of either section. A hinge 135 or multiple hinges may join the first and second head sections 120, 125 together; such hinges are generally in line with the head axis 130.

As previously mentioned, the emotive companion 100 is shown in a standby state in FIG. 1. While in its standby state, the emotive companion is typically stationary with no elements moving. In some embodiments, however, the emotive companion 100 may include a motion sensor, light sensor, sonic (such as ultrasound) sensor, or other presence sensor. In these embodiments, the emotive companion may sense motion within a threshold distance and react to that motion. For example, the emotive companion 100 may exit a low-power mode upon sensing motion. As yet another example, the emotive companion may raise the first or second head sections 120, 125 slightly by rotating one or both about the head axis 130, or may rotate its base about a second axis of rotation (the “base axis”). Such motions may indicate to a user that the emotive companion is active and ready to receive a command or other input. In some embodiments, the emotive companion 100 may move, whether constantly or intermittently, during its standby state. For example, the emotive companion 100 may execute one or more movements that emulate or resemble a stretch or a settling motion, or the like, to indicate the companion is available to accept an input but not presently engaged. All of these motions are examples of contextual information.

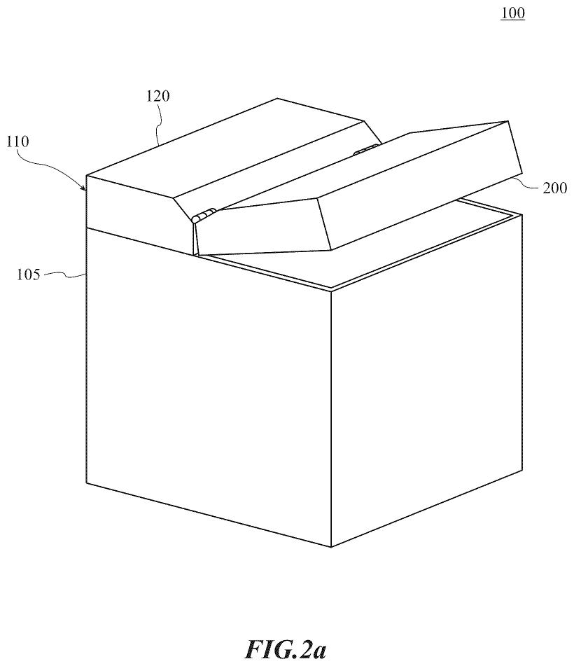

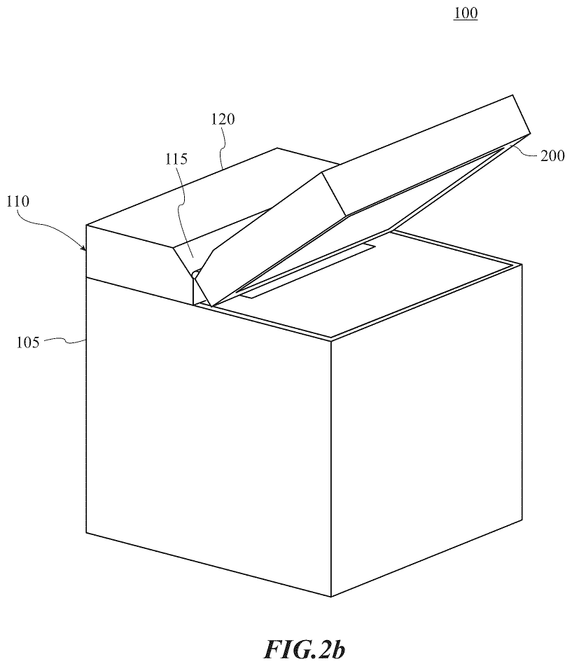

The degree of motion may also be contextual information, or a portion of the contextual information. A smaller motion may indicate the emotive companion has just exited a sleep mode while a larger motion may indicate the emotive companion is prepared to accept an input. As one non-limiting example, a head section may make a relatively small rotational motion, for example rotating somewhere between five and 20 degrees, to lift an outer edge of the head section a small distance away from the base as shown in FIG. 2a. This may correspond to, or be initiated when, the emotive companion wakes from a sleep or other low-power state, or when it is initially powered (e.g., enters a waking state). The same head section may make a larger rotational motion, for example rotating 30 to 60 degrees, to indicate the emotive companion is in a state where it is receptive to an input (e.g., a “listening state,” although inputs may be provided by voice, touch, or other modality, depending on the input sensors of the emotive companion), as shown in FIG. 2b.

As humans generally interpret larger motions to be more energetic and/or excited than smaller, similar motions, the emotive companion may leverage this interpretation to provide intuitive contextual information to a user. Thus, a first motion that is smaller in scope or distance may convey a first meaning while a second motion that is larger in that same or similar scope or distance may convey a second meaning. The wake/input ready example already provided illustrates this concept.

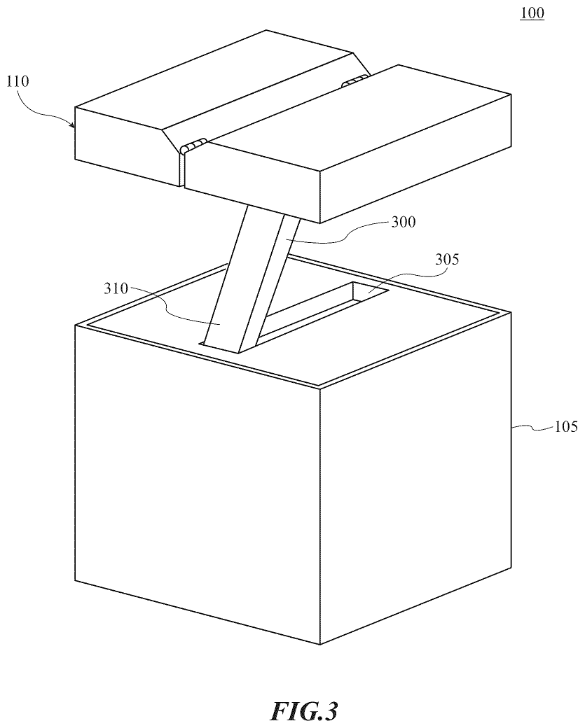

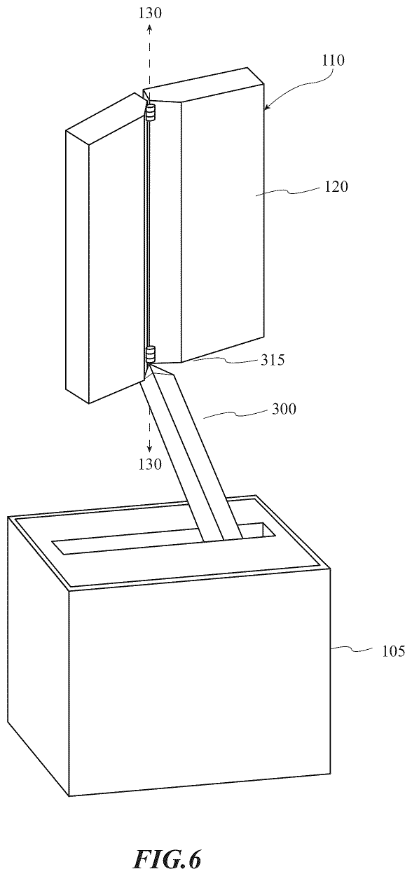

The head 110 may move away from the base 105 (e.g. vertically) as shown in FIG. 3, in addition to rotating about the head axis 130. An arm 300 is connected to the head 110 by a head pivot 315 (shown to beset effect in FIG. 6) and the base by a base pivot 310. The arm 300 can rotate about the base pivot within a single plane or multiple planes (e.g., the arm may revolve around the base pivot and/or may rotate within a conical volume or region having its point at the base pivot). This rotation moves the head 110 relative to the base 105 as the arm 300 is fixed to both the head and the base and (at least in this embodiment) is of a rigid, fixed length. Accordingly, as the arm rotates, the emotive companion “opens” in that the head moves away from the body, exposing surfaces of the companion that were concealed while it is in the standby position. In some embodiments, the arm may have multiple degrees of freedom.

A base receptacle 305 receives the arm 300 when the emotive companion 100 is in the standby position of FIG. 1, such that the arm is fully or substantially fully positioned within the base receptacle. As the arm rotates, much of its length exits the base receptacle although a base end of the arm remains in the base receptacle insofar as the base pivot is within the base receptacle.

The emotive companion 100 is not limited to a single motion at any given time, nor is it limited to a single moving clement at any given time. For example, the arm 300 can rotate about the base pivot 310 to move the head 110 away from the base 105 while the head rotates about the head pivot 315 to maintain substantially parallel alignment between the head and base. A viewer would perceive the head as moving both vertically and laterally with respect to the base. The position of the head in FIG. 3 is a result of this example compound movement.

Many motions that convey contextual information are compound movements, although some are single (or “simple”) movements. It should be noted that one element may rotate about more than one axis at a time, for example when a ball joint joins the element to another element. As one example the head 110 may be joined to the arm 300 by a ball joint, which may be the head pivot 315. As another example, the arm may be joined to the base by a ball joint, which may be the base pivot 310.

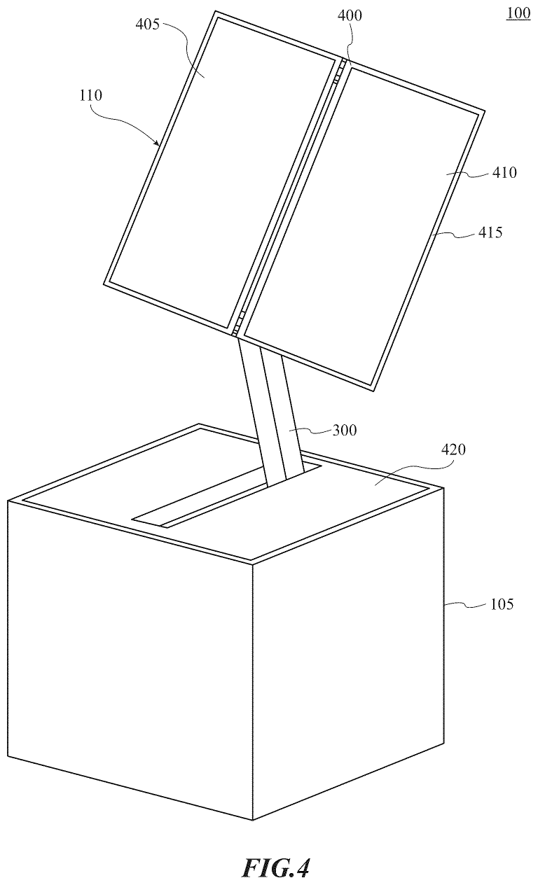

FIG. 4 illustrates the emotive companion 100 in a listening state. It should be appreciated that this is but one example of the emotive companion's position during a listening state and other positions are contemplated. Furthermore, the emotive companion 100 may occupy the same or a similar position when providing information to a user (a “response state”). Both listening states and response states are examples of an active state.

Here, the arm 300 is substantially fully extended from the base 105, with a display side of the head 110 substantially in a plane perpendicular to a display side of the base. The “display side” of the head includes first and second head displays 405, 410 configured to show graphical information although, in some embodiments, the display side of the head may include a single display or more than two displays. For example, a foldable display may form the display side of the first and second head sections 120, 125. The first and second head displays 405, 410 are typically inset within the head, such that a head rim 415 encompasses the head displays and forms part of the head display surface. This is not necessary, however, and in some embodiments the head displays (and, optionally, the base display 420 mentioned below) extend edge-to-edge across a respective display surface.

Similarly, a base display surface may be primarily defined by a single base display 420, although in alternative embodiments multiple base displays 420 may define the base display surface. The channel 115 is formed in the base display surface and the base display 420 typically does not extend into the channel. The base display may be inset into the base 105, such that a base rim that is integral with one or more base sidewalls encompasses the base display and forms part of the base display surface.

The first and second head displays 405, 410, as well as the base display 420, are each configured to display graphics, text, textures, or other information. Responses to search queries may appear on any or all of the head and base displays 405, 410, 420, for example, as may any other visual information provided to a user in response to an instruction. Examples of visual information include characters, graphics, text, or a combination thereof. In some embodiments, any or all of these displays 405, 410, 420 may depict information related to, or synced with, another output of the emotive companion. For example, song lyrics or audio transcriptions may be shown while the emotive companion 100 outputs corresponding audio through a speaker.

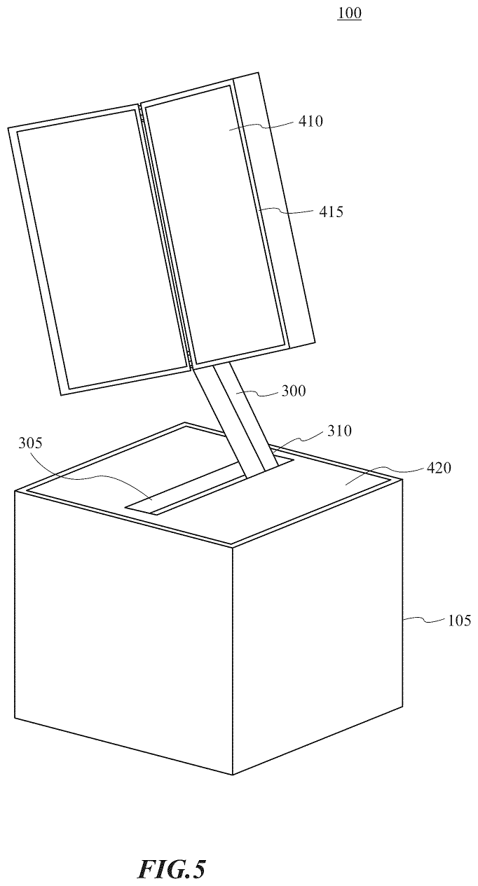

FIG. 5 shows the head 110 in a different, tilted position with respect to the base 105 as compared to FIG. 4 as another example of an active state. This motion may be accomplished by the head 110 rotating about the head pivot 315, by the arm 300 rotating about the base pivot 310, or a combination of both. Further, the first and second head sections 120, 125 are at an acute angle with respect to one another, as measured along the head display side, as opposed to the oblique angle shown in FIG. 4. This is another example of a complex movement executed by the emotive companion 100 as it transitions from the position shown in FIG. 4 to that of FIG. 5, as the head 110 tilts relative to the base 105 and the head sections move relative to one another. The net effect is to move the head 110 from side to side with respect to the perspective of a person looking at the emotive companion 100 shown in the perspective of FIGS. 4 and 5. As also shown in FIG. 5 and in comparison to its position in FIG. 3, the arm 300 may move laterally along the channel 115 in certain embodiments, and the base pivot 310 may move with the arm.

The motion of the emotive companion's head 110, and optionally arm 300, from the position shown in FIG. 4 to the position shown in FIG. 5 may convey contextual information to a viewer. Further, the speed of such movement may vary depending on the contextual information to be conveyed. For example, if the head 110 moves rapidly between the positions shown in FIGS. 4 and 5, a viewer may interpret this as excitement, eagerness, or readiness to accept an input or provide an output. This interpretation may be based on a viewer anthropomorphizing the emotive companion and equating its motion to a common human motion in the viewer's experience and/or culture, such as bouncing or shaking with excitement. As previously mentioned, the emotive companion's particular motion may vary with its location, a user's preferences or understandings, or other factors to ensure the emotive companion's motion(s) convey the appropriate contextual information. As yet another example, if the head 110 moves slowly between the positions shown in FIGS. 4 and 5, a viewer may interpret this contextual information as hesitation, uncertainty, or negativity and so discount or be skeptical about associated primary information displayed by the emotive companion 100 on either of the head displays 405, 410 and/or the base display 420. Again, this particular interpretation may be based on a viewer or user's background, location, culture, or the like, and so may vary accordingly. Generally and with the exception of a waking state or animation, the emotive companion only moves when it is in an active state, or to transition between an active state and standby state.

FIG. 6 shows the rear surface of the emotive companion's head 110, as attached to the arm 300 at the head pivot 315. In some embodiments the head pivot is a spherical joint, while in others a different type of joint, such as a revolute, spherical or prismatic joint, may be used. The head pivot 315 permits the head 110 to articulate without requiring the arm 300 to move. The head pivot 315 is typically located on the head axis 130 about with the first head section 120 and second head section 125 may rotate. Here, the head pivot 315 is adjacent a hinge connecting the head sections but that need not be the case in other embodiments.

In addition to motion of the head 110 about the head pivot 315 and thus about the arm 300, the first and second head sections 120, 125 may open or close, as previously discussed. Thus, not only can the head rotate, revolve, or otherwise move about the head pivot but the first and second head sections may rotate about the head axis 130. These motions may occur simultaneously or separately.

Having described the general operation and structure of one example of an emotive companion, certain functionality and features of the example emotive companion will now be discussed.

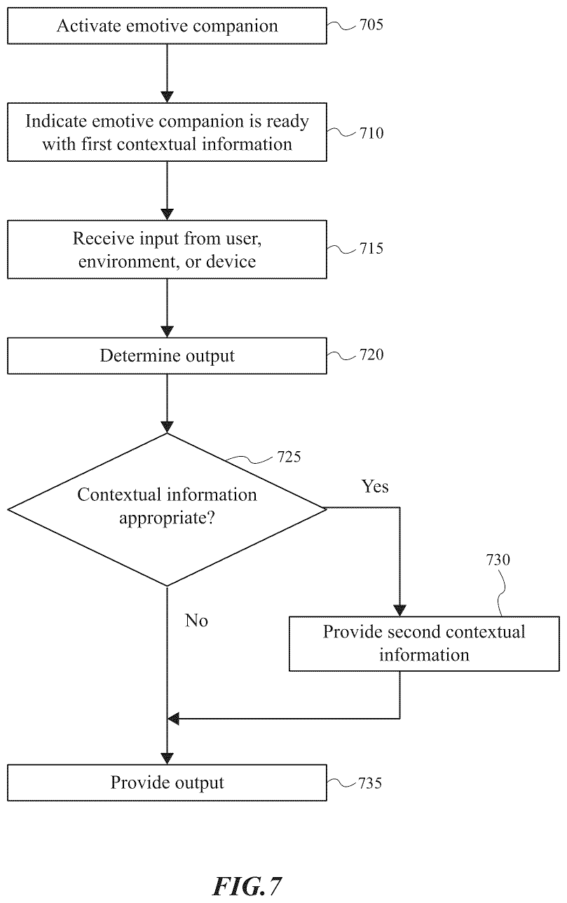

FIG. 7 is a flowchart depicting an example method for receiving an input, providing an output, and providing contextual information related to the output. The method 700 begins in operation 705, in which the emotive companion is activated. The emotive companion can be activated by a user, an environmental change, receipt of data from another device (across a network or otherwise), and so on. The emotive companion can be activated from a powered-down state, sleeping state, waiting state, and so on.

Next, in operation 710, the emotive companion outputs a first example of contextual information to indicate it is ready to receive an input (e.g., the emotive companion is in a state of readiness). The emotive companion may open by moving the head away from the body, for example. The emotive companion may additionally shake the head rapidly from side to side, “nod” the head by moving it forwards and backwards (e.g., towards and away from a front side of the emotive companion), “bob” the head by moving it towards and away from the base, or otherwise moving the head relative to the body. The motion of the head may convey or emulate excitement or eagerness, for example, to indicate the emotive companion is ready to accept input. Such motions are examples of first contextual information.

In operation 715, the emotive companion receives an input. The input may come from a user; one example of such an input is a user instruction to perform an action. Such instructions or interactions may be provided verbally, via touch, by pressure or force, through a gesture (whether physically touching the emotive companion or near the emotive companion), and so on. Sample actions include searching the Internet, a local database or the like for particular information; creating a calendar entry or reminder; creating and/or transmitting an electronic message, voice or audiovisual communication, or other data; accessing or executing an application, whether resident on the emotive companion or remote from the electronic companion; updating or configuring parameters of the electronic companion; and so on. As another option, the input may be environmental. Examples of environmental inputs include: detecting a person approaching the emotive companion; a change in light levels on the emotive companion; a change in pressure experienced by the emotive companion; a change in temperature; and the like. As yet another option, the input may be provided by another electronic device, for example by receiving data from the other electronic device.

In operation 720, the emotive companion determines an output related to the input. This output may be received from another computing device, database, or other informational store or may by generated by the emotive companion with or without reference to any of the foregoing. The output may be a response to a search query, initiating an application, outputting a calendar entry, outputting a reminder, outputting a confirmation of an action, and so on. The output may be visual, audible, haptic, or some combination thereof. The output is one example of primary information as described herein.

In operation 725 the emotive companion determines whether contextual information should accompany the output (e.g., whether contextual information is appropriate). Certain outputs may benefit from contextual information while others may not, and the contextual information is generally related to, or based on, the output. For example, the emotive companion may provide contextual information where primary information (e.g., the output of operation 720) is uncertain or where it is especially relevant. The contextual information may take the form of slow movements where the primary information is uncertain, emulating a hesitant acknowledgement, a shrug, or the like. Alternately, the contextual information may take the form of rapid movements conveying or emulating excitement or eagerness where the primary information is especially relevant or certain. Different types of contextual motion may be used for different outputs and may vary with the accuracy or certainty of the output, a time taken to provide the output, an analysis of a user's attention respective to the emotive companion, the nature or type of the output, and so on. The first contextual information may be a motion designed to attract or elicit a user's attention, signal that primary information is available, a gesture designed or intended to elicit a particular emotion from the user (or emulate a particular emotion), and the like. The contextual information, where it is a gesture emulating an emotion or eliciting an emotion, may emulate or elicit an emotion associated with the primary information or the input. As one non-limiting example, the emotive companion may make a gesture designed to indicate or elicit sadness if the primary information is negative, happiness if the primary information is positive, surprise for unexpected primary information, curiosity for unusual primary information, and so on. Essentially, the emotive gesture or other contextual information may be determined and provided based on the emotive companion's (or another, related computing device's) analysis of the primary information and/or determination of a user's response or reaction to the primary information. Further, it should be noted that operations 720 and 725 may be varied, such that operation 725 occurs prior to, or simultaneously with, operation 720.

In the event such contextual information related to the primary information (output) is appropriate, the emotive companion executes operation 730 in which this second contextual information is provided to the user. The second contextual information may provide context to or regarding the primary information. The context may be an estimate or analysis of the primary information's accuracy with respect to the input, a speed with which the primary information is retrieved or determined, a gesture designed to emulate or elicit emotion as described above, or the like. The second contextual information characterizes the primary information and provides the user with some estimation or analysis of the primary information's veracity, accuracy, relevance, value, emotional context, emotional weight, or the like. This provides a user with some characterization of, or information regarding, the output and/or the user's likely reaction to the output even before the output is given to the user. The emotive companion may emotionally prime the user to receive the output and provide advance notice of how the output may be received by the user.

Following operation 730, or in the event the emotive companion determines in operation 725 that contextual information is inappropriate, the emotive companion executes operation 735 and provides the output. It should be noted that operations 730 and 735 may be executed simultaneously or switched, such that the output is provided prior to the contextual information.

As discussed elsewhere herein, an emotive companion can provide or relay primary information to a user or viewer in a variety of ways. Primary information may be displayed on any of the displays, including either head display and/or the base display. Primary information may be conveyed audibly, through a speaker, headphone, earphones, or the like. As another option, primary information may be conveyed through touch, such as through a haptic feedback device within (or associated with) the emotive companion. In some embodiments any or all of the foregoing may be used in concert with one another to output primary information.

Contextual information, by contrast, is typically conveyed through motion of the emotive companion. The head, arm, body, and/or other physical elements may move to provide contextual information. These contextual motions may be accompanied by audio, haptic, or visual cues to draw attention to the motion or enhance the contextual information provided by the motion of physical elements of the emotive companion. Generally, the contextual information may duplicate, emulate, or otherwise call to mind a particular gesture or emote that corresponds to, or elicits, a particular emotion or concept. The contextual information may vary with any or all of: a location of the emotive companion; the associated primary information; time (whether time of day, date, or both); user preferences; user characteristics; environmental conditions; and so forth.

Contextual information may change. That is, a particular contextual motion or set of motions may be refined or adjusted through user input and/or preference, for example. As another example, artificial intelligence (including, but not limited to, machine learning and deep learning) can measure a user's or viewer's response to contextual information, compare that response versus an expected response, and adjust contextual information accordingly to provide more easily understood, recognized, and/or accurate contextual information for any given primary information or situation. The emotive companion may measure a length of time taken to respond to contextual information, a type of response to contextual information, an emotion experienced in response to contextual information (for example, through facial or gestural recognition, or querying a user), and so on in order to determine whether the contextual information is accurate (e.g., whether it elicits the desired response and/or emotion). Depending on the sensed or inputted data, the contextual information may be adjusted accordingly.

Contextual information may change with a user's state. For example, contextual information may change to acknowledge, accommodate, or respond to a user's emotional state. As one example, an emotive companion may use muted gestures or other outputs when a user is agitated, engaged in conversation with another person, if the primary information relates to a person or topic not of interest to a user or “muted” by the user, and so on. Conversely, gestures or other outputs may be exaggerated if the primary information is of particular interest or urgency, during a time that a user has indicated is suitable for receiving contextual information, and the like.

The emotive companion may use contextual information to modify or influence a user's state, as well. As one non-limiting example, the emotive companion may delay contextual information associated with low-priority primary information when a user appears agitated, under stress, or in another negative emotional state. Conversely, the emotive companion may present contextual information associated with primary information that the user may find uplifting or enjoyable when the user is in a negative emotional state. By monitoring the user's emotions and incorporating them into its decision making, the emotive companion can prioritize both contextual information and primary information, as well as select a particular mode, set, or style of contextual information to be presented to the user. Thus, the emotive companion may enhance positive emotions and lessen negative emotions through its interaction with a user.

An emotive companion may use a variety of sensors and/or software to detect a user's emotional state in order to perform the above analyses and actions. Cameras, microphones, distance sensors, motion sensors, and the like may all provide data that can be analyzed to determine the user's emotional state. Further, this data may be analyzed and/or aggregated over time, such that the emotive companion can use past data and analysis to form a predictive model of a user. The predictive model may be refined based on the user's interaction with the emotive companion (including instructions to the emotive companion and reactions to its primary and/or contextual information), additional data received by the emotive companion, a speed with which a user reacts to the emotive companion, primary information received on the user's behalf, how the user interacts with applications executing on or executed by the emotive companion, and so on. The resulting predictive model may be utilized by the emotive companion to determine whether to present primary information or contextual information, how to present such information, how to otherwise interact with the user, when to present such information, to anticipate input from the user and/or reactions to output by the user, and so on. Thus, with time, the emotive companion may learn a user's physical and/or emotional reactions to certain information, preferred modes of interaction with the user, whether or when to interact with the user without requiring an input (e.g., providing unsolicited information or otherwise engaging a user in advance of the user interacting with the emotive companion), and so on. This allows the emotive companion to be more effective in its operation and more pleasurable in operation and interaction for the user.

Generally, contextual information is more than a simple audible cue or response from the emotive companion. Audible output is typically inefficient and limited in its ability to emulate or elicit emotion by itself. Further, in many examples of personal assistants or other electronic products, an audible output is primary information rather than contextual information. For example, a conventional voice assistant uses audio output to provide search results, scheduling results, and primary responses to user input; all of these are examples of primary information. Voice assistants generally do not provide contextual information for their audible outputs. Additionally, audible outputs from voice assistants or other personal assistants are temporally limited and constricted in the range of outputs that can be easily and/or pleasingly provided (e.g., provided without utilizing sounds that are painful or irritating to a listener). The emotive companions described herein may have a wider and more nuanced range of options for contextual output through the use of motion of elements of the emotive companions, as generally described herein.

Certain emotive companions may have a physical structure that corresponds or analogizes to a human body, at least in some respects. Further, such an emotive companion may be configured to move its physical structure in a way that emulates human gestures in order to convey contextual information. For example, the emotive companion 100 shown in FIG. 1 includes a base 105 that may be an analog for a human torso with respect to certain contextual information generated by the emotive companion. Similarly, the head 110 may analogize to a human head or hand, while the arm 300 may analogize to a human neck or arm. The head sections 120, 125 may analogize to human eyes or fingers, depending on the contextual information outputted by the emotive companion 100. The specific motion making up the contextual information (or conveying the contextual information) may thus be modeled on corresponding gestures of the human body, making the contextual information easier to interpret by a viewer. In certain embodiments the base may likewise move, for example by rocking, spinning, and/or translating, thereby providing a larger universe of potential movements for contextual information, whether corresponding to motion of the base alone or in conjunction with motion of the arm, head, or other physical element of the emotive companion.

An emotive companion may take a variety of different forms beyond those shown and discussed above. Certain embodiments of an emotive companion may lack a physical element described herein, such as an arm, may have a single head section (e.g., lack separate first and second head sections), more or fewer displays, and so on. Embodiments may have different shapes or differently shaped physical elements. An emotive companion may be spherical an oblate spheroid, pyramidal, rectangular prism, or other polyhedron. Some emotive companions may lack a channel or have multiple channels. Still other emotive companions may have multiple arms or other movable physical elements. There is no requirement that the emotive companion resemble a human or otherwise be anthropomorphized, nor that its contextual information be analogized to human gestures. As one non-limiting example, the emotive companion may employ gestures or provide other output (including audio or visual output) that may be understood by a human but lacks any corresponding human gesture, such as rapid vibration, thermal outputs, animal-like gestures, specialized contextual information, and so on. Accordingly, the shape and structure of the emotive companion described herein and illustrated in the accompanying figures is illustrative rather than limiting.

An emotive companion may be modular, in that additional modules or structures may be added to the emotive companion to enhance the emotive companion's functionality. Sensors may be added to the emotive companion by connecting a sensor module, as one example, to extend the interactive capability of the emotive companion. Additional motors or motive elements may likewise be added to move portions of the emotive companion that otherwise do not move, thereby providing additional potential contextual information. Additional modular functions may be added, such as extended batteries, additional outputs, and the like. Further, some or all of the emotive companion may be located remotely from its shell. As one non-limiting example, a processing unit, memory, software, firmware, or other operational component may be networked to the emotive companion's shell.

Although the operation of the emotive companion is generally described herein as accepting inputs and providing outputs, including primary and contextual information, its operation is not necessarily limited to these modalities. For example, the emotive companion may act collaboratively with a user, another emotive companion, a system, and so on.

In some cases, a single emotive companion may have multiple users. The emotive companion may keep separate predictive models for each user in order to tailor its operation to each user separately. Additionally, the emotive companion may indicate when it shifts focus from one user to another by providing a unique output, which may be a form of contextual information. For example, when configuring itself to operate or interact with a second user instead of a first user, the emotive companion may perform a gesture such as returning briefly to its standby state, moving in a particular way, and returning to its active state to signal the transition between users. This transition does not necessarily prevent the emotive companion from interacting with anyone other than the second user but instead signals that the emotive companion has configured itself (including its software) to regard the second or new user as its primary user. This may include, among other things, loading the second user's predictive model, preferences, forms of contextual information, and so forth, essentially personalizing the emotive companion for the given user.

Given the emotive companion's ability to determine a user's emotional state and its user predictive model, the emotive companion may be uniquely suited to provide a facsimile of companionship for the user. The emotive companion may tailor its contextual information and other user interactions to the particular user, as previously discussed. Further, the emotive companion may proactively access and provide primary information (optionally, along with contextual information) that the emotive companion determines is of interest to the user. This proactive information may be presented in a variety of ways, including conversationally. That is, in some embodiments, the emotive companion may initiate conversation with the user about a topic of interest, e.g., by asking the user a question (“Did you know . . . ”) or stating a declaration (“You might be interested in . . . ”) about a subject the emotive companion has determined may be of user interest. In some cases, this interaction may not be related to any primary information at all but instead may be designed to elicit user input. As one example, the emotive companion, upon determining through its predictive model that the user is or may be sad, might ask the user how he or she is feeling. As another example, if the user is present when his or her calendar indicates the user should be elsewhere, the emotive companion might ask the user why he or she skipped an appointment. The user answers may be used as input to continue a conversation or other interaction, including gestural outputs intended to emulate or express certain emotions such as empathy, sympathy, agreement, curiosity, and so on. In this way the emotive companion may fulfill needs beyond simply transactional interactions. Further, the emotive companion may limit such non-transactional interactions or steer them in certain directions in the event the interactions are determined to be non-beneficial. For example, if the user continues to miss appointments or stay near the emotive companion, the companion may prompt the user to reduce its reliance on, or attachment to, it or otherwise encourage the user to interact with others.

Although the emotive companion has been described with respect to a particular form as shown in the accompanying figures, there is no reason or requirement that the companion take that form. Further, the emotive companion may be modular, such that additional functionality is enabled for the emotive companion as a module or modules are added. These modules can electrically, wirelessly, and/or physically connect to the emotive companion's base form (one example of which is shown in the accompanying figures), thereby allowing the emotive companion access to a greater range of actions, outputs, inputs, motions, or the like, depending on the nature of the added module. As one non-limiting example, a module may be added to the emotive companion to enable a new form of movement; a drone base may permit the emotive companion to fly or hover, while a wheeled base may permit the emotive companion to roll. As another non-limiting example, modules may provide additional sensors to the emotive companion, such as infrared or ultrasonic sensing modules.

While the emotive companion, in the form discussed through the majority of this specification, includes inbuilt displays, the emotive companion is not limited to using those displays (or indeed limited to using any of its forms of output). The emotive companion may employ any suitable communication protocol or signal to connected (whether wirelessly or through a physical connection) with external displays, speakers, haptic actuators, motors, or the like. Further, these external outputs need not be modules as described above, although they could be. Rather, existing external devices such as a television, audio system, or the like may be linked to the emotive companion, thereby permitting the emotive companion to utilize these devices' capabilities.

As discussed elsewhere herein, the emotive companion generally learns and adapts its output and behavior to a user. With a sufficient data set for a user, the emotive companion may be able to anticipate commands or other inputs, or interpolate commands/inputs from partial data. This may permit the emotive companion to provide contextual information and/or primary information before a user finishes inputting a command. The emotive companion may determine a user's likely command from partial input data and execute that command, or provide contextual information indicating it has anticipated the full command, before the input finishes. (To the extent the input is not a command, the emotive companion may similarly react before the input is finished.) As one example, the emotive companion could shake, “nod” its head, or otherwise provide a gestural output to indicate the emotive companion is anticipating the user's input. This is one example of a substantially real-time response that the emotive companion may provide to a user to enhance interaction.

It should be appreciated that the emotive companion may provide a substantially real-time response even without a user data set, as described above. For example, the emotive companion may utilize a first gesture when the emotive companion understands or accepts a partial input (e.g., indicating that an ongoing command can be acted upon by the emotive companion) but utilize a second gesture when the emotive companion determines from the partial input that it cannot execute any possible command that follows from the partial input, or that it cannot process any input that follows from the partial input. As with other non-limiting example sin this specification, the first and second gestures may mimic or evoke related human gestures, such as moving the head up and down (“nodding” its head) to indicate comprehension or moving the head left to right (“shaking” its head) if it does not understand the partial or full input. By providing substantially real-time feedback while the user is providing input, the emotive companion may prompt the user to rephrase or otherwise change his or her input so that it is acceptable to the emotive companion. Other substantially real-time responses may be utilized by the emotive companion in addition to those described.

It should be appreciated that certain examples of the emotive companion may be fully virtual rather than physical, being embodied fully in software or firmware rather than hardware. Such embodiments may nonetheless provide contextual and primary information as described herein, interact with users as described herein, and otherwise provide virtual analogs to any physical action or activity discussed herein. Further, the emotive companion may, in some cases, incorporate both a physical and virtual form. For example, the emotive companion may have a physical form and physical capabilities as generally discussed in this specification but may also be connected to a network, virtual reality, another computing product, or the like in order to provide virtual functionality above and beyond the physical functionality of the physical product itself. Further, insofar as the virtual instantiation of the emotive companion is controlled by, or connected to, the software operating the physical emotive companion, the emotive companion may provide continuity of response, knowledge, and learning between its physical and virtual instantiations. Additionally and as previously mentioned, the controlling software may be executed remotely from either or both of the virtual and physical emotive companions, or may be executed at the physical emotive companion, or may be executed on hardware displaying or outputting the virtual emotive companion.

As discussed elsewhere herein, the emotive companion may learn a user's preferences, which gestures are preferred by a user, how a user interprets specific gestures, what other contextual information provides knowledge to a user, and so on. As also discussed, the emotive companion may utilize machine learning, a neural network, artificial intelligence, and the like to conform itself (or at least its outputs, including contextual information) to a user. However, the emotive companion may be generally trained through such mechanisms to have a baseline set of functions, expressions, gestures, and other contextual information. The emotive companion may be trained on motion capture data, hand animation of sample movements, captured video of sample movements, and the like to create its baseline set. Machine learning, artificial intelligence, and the like may also be utilized to link the contextual information output to different combinations of inputs, such that the baseline set provides meaningful output to a user even without customization.

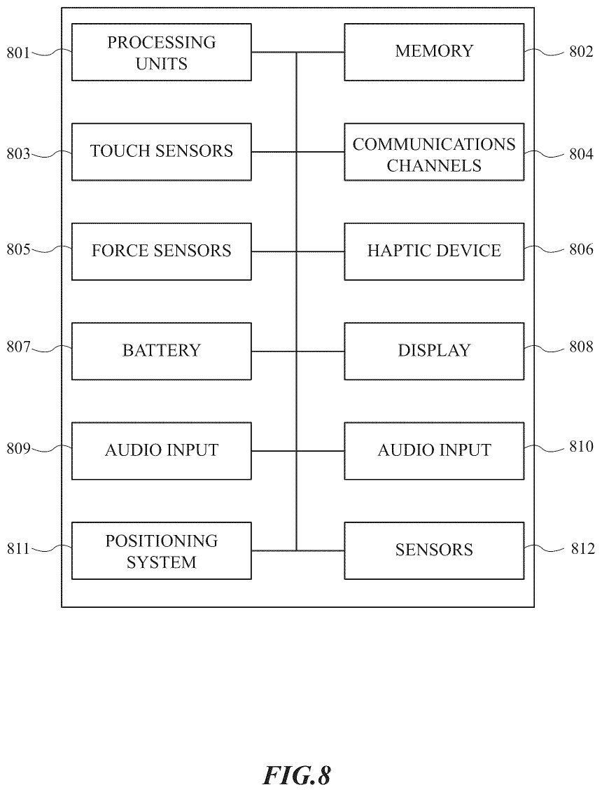

FIG. 8 depicts an example schematic diagram of an electronic product 800 such as an emotive companion as described herein. The electronic product 800 may be an embodiment of or otherwise represent the emotive companion 100. The product 800 includes one or more processing units 801 that are configured to access a memory 802 having instructions stored thereon. The instructions or computer programs may be configured to perform one or more of the operations or functions described with respect to the electronic products described herein. For example, the instructions may be configured to control or coordinate the operation of the head (and its constituent sections), the arm, or the base, one or more displays 808, one or more touch sensors 803, one or more force sensors 805, one or more communication channels 804, one or more audio input systems 809, one or more audio output systems 810, one or more positioning systems 811, one or more sensors 812, and/or one or more haptic feedback devices 806.

The processing units 801 of FIG. 8 may be implemented as any electronic component capable of processing, receiving, or transmitting data or instructions. For example, the processing units 801 may include one or more of: a microprocessor; a central processing unit (CPU); an application-specific integrated circuit (ASIC); a digital signal processor (DSP); or combinations of such devices. As described herein, the term “processor” is meant to encompass a single processor or processing unit, multiple processors, multiple processing units, or other suitably configured computing element or elements. The processing units 801 may be coupled to a circuit board assembly, such as the circuit board assemblies described herein.

The memory 802 can store electronic data that can be used by the product 800. For example, a memory can store electrical data or content such as, for example, audio and video files, images, documents and applications, product settings and user preferences, programs, instructions, timing and control signals or data for the various modules, data structures or databases, and so on. The memory 802 can be configured as any type of memory. By way of example only, the memory can be implemented as random access memory, read-only memory, Flash memory, removable memory, or other types of storage elements, or combinations of such devices. The memory 802 may be coupled to a circuit board assembly, such as the circuit board assemblies described herein.

The touch sensors 803 may detect various types of touch-based inputs and generate signals or data that are able to be accessed using processor instructions. The touch sensors 803 may use any suitable components and may rely on any suitable phenomena to detect physical inputs. For example, the touch sensors 803 may be capacitive touch sensors, resistive touch sensors, acoustic wave sensors, or the like. The touch sensors 803 may include any suitable components for detecting touch-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The touch sensors 803 may be integrated with or otherwise configured to detect touch inputs applied to any portion of the product 800. For example, the touch sensors 803 may be configured to detect touch inputs applied to any portion of the product 800 that includes a display (and may be integrated with a display). The touch sensors 803 may operate in conjunction with the force sensors 805 to generate signals or data in response to touch inputs. A touch sensor or force sensor that is positioned over a display surface or otherwise integrated with a display may be referred to herein as a touch-sensitive display, force-sensitive display, touchscreen display, or touchscreen.

The force sensors 805 may detect various types of force-based inputs and generate signals or data that are able to be accessed using processor instructions. The force sensors 805 may use any suitable components and may rely on any suitable phenomena to detect physical inputs. For example, the force sensors 805 may be strain-based sensors, piezoelectric-based sensors, piezoresistive-based sensors, capacitive sensors, resistive sensors, or the like. The force sensors 805 may include any suitable components for detecting force-based inputs and generating signals or data that are able to be accessed using processor instructions, including electrodes (e.g., electrode layers), physical components (e.g., substrates, spacing layers, structural supports, compressible elements, etc.), processors, circuitry, firmware, and the like. The force sensors 805 may be used in conjunction with various input mechanisms to detect various types of inputs. For example, the force sensors 805 may be used to detect presses or other force inputs that satisfy a force threshold (which may represent a more forceful input than is typical for a standard “touch” input). Like the touch sensors 803, the force sensors 805 may be integrated with or otherwise configured to detect force inputs applied to any portion of the product 800. For example, the force sensors 805 may be configured to detect force inputs applied to any portion of the product 800 that includes a display (and may be integrated with a display). The force sensors 805 may operate in conjunction with the touch sensors 803 to generate signals or data in response to touch-and/or force-based inputs.

The product 800 may also include one or more haptic devices 806 (e.g., the haptic actuator 222, 322 of FIGS. 2-3). The haptic device 806 may include one or more of a variety of haptic technologies such as, but not necessarily limited to, rotational haptic devices, linear actuators, piezoelectric devices, vibration elements, and so on. In general, the haptic device 806 may be configured to provide punctuated and distinct feedback to a user of the device. More particularly, the haptic device 806 may be adapted to produce a knock or tap sensation and/or a vibration sensation. Such haptic outputs may be provided in response to detection of touch and/or force inputs, and may be imparted to a user through the exterior surface of the device 800 (e.g., via a glass or other surface that acts as a touch-and/or force-sensitive display or surface).

The one or more communication channels 804 may include one or more wireless interface(s) that are adapted to provide communication between the processing unit(s) 801 and an external device. The one or more communication channels 804 may include antennas (e.g., antennas that include or use housing components as radiating members), communications circuitry, firmware, software, or any other components or systems that facilitate wireless communications with other devices. In general, the one or more communication channels 804 may be configured to transmit and receive data and/or signals that may be interpreted by instructions executed on the processing units 801. In some cases, the external device is part of an external communication network that is configured to exchange data with wireless devices. Generally, the wireless interface may communicate via, without limitation, radio frequency, optical, acoustic, and/or magnetic signals and may be configured to operate over a wireless interface or protocol. Example wireless interfaces include radio frequency cellular interfaces (e.g., 2G, 3G, 4G, 4G long-term evolution (LTE), 5G, GSM, CDMA, or the like), fiber optic interfaces, acoustic interfaces, Bluetooth interfaces, infrared interfaces, USB interfaces, Wi-Fi interfaces (e.g., for communicating using Wi-Fi communication standards and/or protocols, including IEEE 802.11, 802.11b, 802.11a, 802.11g, 802.11n, 802.11ac, 802.11ax (Wi-Fi 6, 6E), 802.11be (Wi-Fi 7), or any other suitable Wi-Fi standards and/or protocols), TCP/IP interfaces, network communications interfaces, or any conventional communication interfaces. The one or more communications channels 804 may also include ultra-wideband (UWB) interfaces, which may include any appropriate communications circuitry, instructions, and number and position of suitable UWB antennas.

As shown in FIG. 8, the product 800 may include a battery 807 that is used to store and provide power to the other components of the product 800. The battery 807 may be a rechargeable power supply that is configured to provide power to the product 800. The battery 807 may be coupled to charging systems (e.g., wired and/or wireless charging systems) and/or other circuitry to control the electrical power provided to the battery 807 and to control the electrical power provided from the battery 807 to the product 800.

The product 800 may also include one or more displays 808 configured to display graphical outputs. The displays 808 may use any suitable display technology, including liquid crystal displays (LCD), organic light-emitting diodes (OLED), active-matrix organic light-emitting-diode displays (AMOLED), or the like. The displays may use a low temperature polycrystalline silicone (LTPS) or low temperature polycrystalline oxide (LTPO) backplane. The displays 808 may display graphical user interfaces, images, icons, or any other suitable graphical outputs. The display 808 may correspond to a display 103, 203, or other displays described herein.

The product 800 may also provide audio input functionality via one or more audio input systems 809. The audio input systems 809 may include microphones, transducers, or other products that capture sound for voice calls, video calls, audio recordings, video recordings, voice commands, and the like.

The product 800 may also provide audio output functionality via one or more audio output systems (e.g., speakers) 810, such as the speaker systems and/or modules described herein. The audio output systems 810 may produce sound from voice calls, video calls, streaming or local audio content, streaming or local video content, or the like.

The product 800 may also include a positioning system 811. The positioning system 811 may be configured to determine the location of the product 800. For example, the positioning system 811 may include magnetometers, gyroscopes, accelerometers, optical sensors, cameras, global positioning system (GPS) receivers, inertial positioning systems, or the like. The positioning system 811 may be used to determine spatial parameters of the product 800, such as the location of the product 800 (e.g., geographical coordinates of the product), measurements or estimates of physical movement of the product 800, an orientation of the product 800, or the like.

The product 800 may also include one or more additional sensors 812 (also referred to as sensing systems) to receive inputs (e.g., from a user or another computer, product, system, network, etc.) or to detect any suitable property or parameter of the product, the environment surrounding the product, people, or things interacting with the product (or nearby the product), or the like. For example, a product may include temperature sensors, biometric sensing systems (e.g., fingerprint sensors, facial recognition systems, photoplethysmographs, blood-oxygen sensors, blood sugar sensors, or the like), eye-tracking sensors, proximity sensors, depth sensors (e.g., time-of-flight based depth or distance sensors), ambient light sensors, retinal scanners, humidity sensors, buttons, switches, lid-closure sensors, or the like.

To the extent that multiple functionalities, operations, and structures described with reference to FIG. 8 are disclosed as being part of, incorporated into, or performed by the product 800, it should be understood that various embodiments may omit any or all such described functionalities, operations, and structures. Thus, different embodiments of the product 800 may have some, none, or all of the various capabilities, apparatuses, physical features, modes, and operating parameters discussed herein. Further, the systems included in the product 800 are not exclusive, and the product 800 may include alternative or additional systems, components, modules, programs, instructions, or the like, that may be necessary or useful to perform the functions described herein.

Embodiments need not take the form shown in prior figures and described above. For example, embodiments may lack a neck and/or head, have different points of articulation, include differently-shaped components (including a head, body, neck, or the like), incorporate sensors and/or displays in different locations, and so on. Further, the motion used to emulate and/or elicit emotion or attention may be different from those described herein and based on the form of a particular embodiment.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. An emotive companion, comprising:
a base;
an arm rotatably and slidably connected to the base; and
a head rotatably connected to the arm, the head comprising:
a first head section;
a second head section; wherein:
the first head section and second head section are rotatable about a head axis;
the first head second and second head section are configured to display primary information;
the head and the arm are configured to move relative to the base to convey contextual information; and
the contextual information relates to the primary information and emulates a human gesture.

2. The emotive companion of claim 1, wherein when the companion is in the standby state, the head and base form a substantially cubical shape.

3. The emotive companion of claim 1, further comprising:
a first display formed on a surface of the first head section; and
a second display formed on a surface of the second head section; wherein:
the first and second displays are concealed when the emotive companion is in a standby state; and
the first and second displays are externally visible when the emotive companion is in an active state.

4. The emotive companion of claim 3, wherein the head and the arm cooperate to move in order to emulate an emotion.

5. The emotive companion of claim 4 wherein, after the head and the arm cooperate to move in order to emulate an emotion, the first display displays information in response to a person's input.

6. The emotive companion of claim 3, wherein the first head section rotates relative to the second head section when the emotive companion enters a waking state.

7. The emotive companion of claim 3, wherein the head and the arm cooperative to move in order to emulate a human gesture.

8. The emotive companion of claim 7, wherein the base moves with the head and the arm in order to emulate the human gesture.

9. The emotive companion of claim 1, wherein the arm moves in a conical volume.

10. A method for providing contextual output from an emotive companion, comprising:
receiving a user input;
determining an output based on the user input, the output comprising primary information;
determining whether contextual information corresponding to the primary information is to be provided, the contextual information configured to elicit an emotion from a viewer;
in the event the contextual information is to be provided, selecting the contextual information from a set of contextual information based on the emotion to be elicited; and
outputting the primary information and the contextual information; wherein:
the contextual information is motion-based.

11. The method of claim 10, wherein the contextual information is an emulated gesture.

12. The method of claim 11, wherein the primary information is visual information.

13. The method of claim 11, wherein:
the emotive companion comprises:
a first portion; and
a second portion attached to the first portion;
the emulated gesture is performed by the first portion; and
the second portion remains stationary during the emulated gesture.

14. The method of claim 11, wherein:
the emotive companion comprises:
a first portion; and
a second portion attached to the first portion; and
the emulated gesture is performed by the first portion and the second portion together.

15. The method of claim 10, wherein the contextual information changes based on the primary information.

16. The method of claim 10, wherein the contextual information changes based on a person requesting the contextual information.

17. A method for evoking an emotion in a user in response to presenting primary information, comprising:
receiving an input from the user;
determining an output related to the input;
determining if contextual information is appropriate, given the input and the output;
in the event the contextual information is appropriate, providing the contextual information in the form of a movement designed to evoke an emotion in the user; and
providing the output.

18. The method of claim 17, wherein the contextual information is second contextual information, and further comprising:
providing first contextual information to the user, the first contextual information different from the second contextual information.

19. The method of claim 18, wherein the first contextual information indicates a state of readiness for the emotive companion.

20. The method of claim 17, wherein the contextual information is selected based on context of the output.
